(19) United States
(12) Patent Application Publication
(10) Pub. No.: US 2009/0056327 A1
(43) Pub. Date: Mar. 5, 2009

(54) Method and Device for Collecting Wave Energy

(76) Inventors: Esko Raikamo, Lempaala (FI); Markku Oikarainen, Lempaala (FI)

Correspondence Address: BIRCH STEWART KOLASCH & BIRCH, PO BOX 747, FALLS CHURCH, VA, 22040-0747, US

(21) Appl. No.: 11/887,967

(22) PCT Filed: Apr. 5, 2006
(86) PCT No.: PCT/FI2006/050127

§ 371 Date: Oct. 5, 2007

(51) Int. Cl. F03B 13/16

(52) U.S. Cl. 60/506; 405/76; 60/497

(57) ABSTRACT

The invention relates to a method and a device for recovering energy contained by waves. The collecting device (8) comprises a float (7) coupled by means of one or more support bars (10, 11) to an actuator (12). At least one support bar is rigidly coupled to the float (7) or to a support member (62) in the float. In addition, the float (7) is arranged substantially entirely below water level.

### BACKGROUND OF THE INVENTION

The invention relates to a method of recovering energy contained by waves, and to a collecting device. The object of the invention is more specifically disclosed in the preambles of the independent claims of the application.

Several solutions have been presented for collecting wave energy and for converting it into pressure energy. FR publication 2 436 888 discloses a float on the surface of water, supported to the body of a collecting device by means of bars articulated to the float. Hydraulic pumps are arranged in connection with the bars for generating hydraulic power as the float moves by the action of waves. However, the problem in such a collecting device is that the movements of the float are not controlled, and thereby the energy contained by the waves cannot be collected in a satisfactory manner.

### BRIEF DESCRIPTION OF THE INVENTION

The object of the present invention is to provide a new and improved method and device for recovering energy contained by waves.

The method of the invention is characterized by arranging the float substantially entirely below the surface of water; and coupling at least one support bar rigidly to the float.

The device of the invention is characterized in that at least one support bar is fastened rigidly to the float without articulation between the float and said support bar.

The second device of the invention is characterized in that the float is coupled to at least one support member; that the support bars are coupled at their first ends to the support member; and that at least one support bar is fastened rigidly to the support member without articulation between the float and said support bar.

An essential idea of the invention is that the upper end of at least one bar is fastened to the float without articulation.

Alternatively, the float is fastened directly or by means of an articulation to a suitable support member, to which the upper ends of the support bars are fastened. In accordance with the idea of the invention, at least one of the upper ends of the bars is fastened to the support member without articulation.

An advantage of the invention is that the movements of the float are controlled, since a bar that is rigid relative to the float prevents the float from ending up in unfavourable positions from the point of view of energy collection. A bar rigidly fastened to the float keeps the float on a controlled, circular or elliptical path.

The essential idea of an embodiment of the invention is that the device comprises means for adjusting the height of the float relative to the surface of water. The mass of the float can be varied for instance by varying the amount of water or air inside the float. In this way, the float can be adjusted in such a manner that it receives the energy contained by the waves in the best possible manner under prevailing wave conditions. Furthermore, it is possible to adjust the float deep in the water in view of storms and ice conditions, whereby damage to the collecting device is avoided. On the other hand, under wave conditions corresponding to normal operating circumstances, the float can be kept at the upper surface layer of water, immediately below the surface by means of adjustment; a location wherein the energy contained by the waves is at its maximum.

The essential idea of an embodiment of the invention is that the float is an elongated cylinder having a substantially round or oval cross-section. The support bars can be arranged at the area of both ends of the cylinder. Alternatively, one or more support bars can be arranged in the middle portion of the cylinder, at a distance from each end.

The essential idea of an embodiment of the invention is that the cross-section of the float comprises a plurality of curved surfaces at different radiuses.

The essential idea of an embodiment of the invention is that the float is box-like and its cross-section may be a square, a rectangle, a parallelogram or a trapezium.

The essential idea of an embodiment of the invention is that a plurality of collecting devices is coupled to constitute a larger whole. Each collecting device may comprise a dedicated motion converter and a dedicated energy converter. This being so, the energy converters of the collecting devices may be coupled in series electrically or by means of a pressure medium. Alternatively, two or more collecting device may be coupled to use mechanically common conversion devices.

The essential idea of an embodiment of the invention is that two or more collecting devices are coupled to use common conversion devices, the same shaft having one or more flywheels.

The essential idea of an embodiment of the invention is that the motion converter is coupled to convert the reciprocating motion transferred to the shafts into a unidirectional rotating motion.

The essential idea of an embodiment of the invention is that the motion converter is coupled to one or more electrical generators, whereby the energy collected from the waves is converted into electrical energy by means of a generator.

The essential idea of an embodiment of the invention is that the motion converter is coupled to one or more pumps that are arranged to pump a medium, such as a gas or a liquid.

The essential idea of an embodiment of the invention is that the motion converter is coupled to use a mechanical device, such as a mill or a saw.

The essential idea of an embodiment of the invention is that the collecting device is supported to the bottom of a water system, such as a sea, a lake or a river, by means of a support structure.

The essential idea of an embodiment of the invention is that the collecting device is supported to the lower side of a superstructure. The waves can pass below the deck and release part of their energy to one or more collecting devices.

The essential idea of an embodiment of the invention is that the collecting device is supported to the lower side of a floating superstructure.

The essential idea of an embodiment of the invention is that the horizontal movement of the float is restricted in a direction transverse to the direction of motion of the waves. This enables the placement of a plurality of collecting devices laterally adjacently without any risk of collision. Furthermore, motion delimiters can be used to lessen the loadings directed to the support bars, the articulations and the rest of the construction.

The essential idea of an embodiment of the invention is that at least one support bar has a flat cross-section, and that the support bar is arranged to have a relatively large surface area in a direction transverse to the direction of motion of the wave, but at the same time a relatively small surface area against the direction of motion of the wave. This being so, the support bar may prevent lateral movements of the float, however, without its flow resistance in the water being high.

### BRIEF DESCRIPTION OF THE FIGURES

Some embodiments of the invention will be described in more detail in the accompanying drawings, in which

FIGS. 1a and 1b schematically show a wave advancing in water and the movement of water molecules in the water,

FIG. 2a schematically shows a side view of a collecting device according to the invention,

FIGS. 2b to 2e schematically show the movements of the float of a collecting device according to the invention by the action of waves,

FIG. 3 schematically shows a perspective view of a second collecting device according to the invention, whose float is supported with four support bars to a body,

FIG. 4 schematically shows a side view of a third collecting device according to the invention, arranged in a vertical wall surface,

FIG. 5 schematically shows a side view of a fourth collecting device according to the invention, comprising at least one support bar, whose longitudinal motion is received with an actuator,

FIG. 6 schematically shows a side view of a fifth collecting device according to the invention, wherein the float is supported with at least one support bar, whose longitudinal motion and turning motion are received in an actuator with its special means,

FIG. 7 schematically shows a manner of arranging a plurality of collecting devices as a larger collecting unit, and the figure also shows a manner of supporting the collecting devices to the bottom by means of a support structure,

FIG. 8 schematically shows a second manner of supporting the collecting devices to the bottom by means of a support structure,

FIG. 9 schematically shows a structure, in connection with which the collecting devices of the invention can be applied,

FIG. 10 schematically shows in partial section a motion converter for converting the reciprocating motion of one or more support bars in a collecting device into a unidirectional rotational motion,

FIGS. 11a and 11b schematically show some manners of coupling two or more collecting devices successively in series or parallel in series,

FIG. 12a schematically shows a collecting device provided with a turning mechanism, and FIGS. 12b and 12c show a top view of the collecting device of FIG. 12a seen in breakers having different directions,

FIG. 13a schematically shows a manner of arranging collecting devices in a superstructure arranged above the surface of water,

FIG. 13b schematically shows a manner of arranging collecting devices in a superstructure and at the bottom of a water system,

FIG. 14 schematically shows a side view of a collecting device according to the invention, wherein a flexible power transmission member is arranged to transfer motion from a float to an actuator,

FIG. 15 schematically shows a side view of a second collecting device according to the invention, comprising two floats and a flexible power transmission member arranged to couple up the floats and transfer motion from the floats to an actuator,

FIG. 16 schematically shows a collecting device according to the invention, wherein an elongated float is supported by means of a plurality of articulated support bars at the middle portion of the float,

FIG. 17 schematically shows an application of the collecting device shown in FIG. 16, wherein support bars are arranged only on one side of the float,

FIG. 18 schematically shows a collecting device according to the invention, wherein a toothed bar or the like is rigidly fastened to the middle portion of a float, and

FIG. 19 schematically shows a collecting device according to the invention, wherein one support bar is rigidly fastened to the middle portion of a float.

For the sake clarity, the figures show the invention in a simplified manner. In the figures, like parts are denoted with like reference numerals.

### DETAILED DESCRIPTION OF SOME EMBODIMENTS OF THE INVENTION

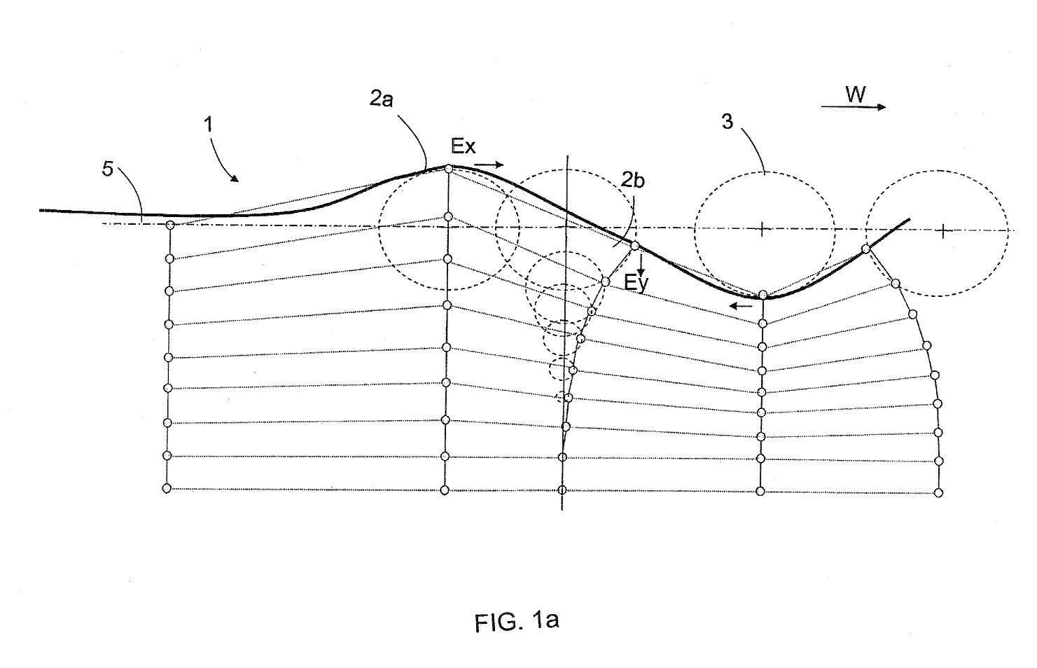

Waves 1 shown in FIGS. 1a and 1b comprise both potential energy Ey and motion energy Ex. Potential energy Ey is generated as a result of a variation in the height of the water molecules in the vertical direction Y. Motion energy Ex, in turn, is generated as a result of a reciprocating horizontal motion of the water molecules 2. When the water molecule 2 is close to the trough of a wave 1, its potential energy Ey is low and motion energy Ex high. The situation is reverse for a water molecule 2 at the crest of a wave 1. By the action of these two simultaneous energies Ex, Ey, the water molecules 2 move along a circular or elliptical, curved path 3. This motion of the water molecules 2 extends by a distance from the surface 5 of water towards the bottom 6. The depth of the motion of the water molecules depends for instance on the magnitude of the distance from the surface 5 to the bottom 6. Similarly, the shape of the curved path 3 depends for instance on the distance of the surface 5 of water to the bottom 6. For example, in the area of so-called free water, wherein the distance to the bottom 6 is long, the curved path 3 may be substantially circular and extend quite deep into the water mass. In contrast, in the area of shallow water, the bottom 6 affects the motion of the water molecules 2 in such a manner that the curved path 3 may take an elliptical form.

FIG. 1b further shows a float 7, which is subject to gravitation G in direction Y. On the other hand, the float 7 in the water is subject to a buoyant force H, whose magnitude depends on the volume V of the float 7 and the density R of the water. The deeper the float 7 is in the water at each particular time, the larger is the buoyant force H. The depth where the float 7 floats in the water can be affected by adjusting the mass of the float 7. It is preferable to arrange the float 7 in the water in such a manner that it is substantially entirely below the surface 5 of water. This being so, its entire surface area may be subjected to the energies contained by the waves. On the other hand, the force acting on the float 7 is at its largest at the surface layers of the water, since the energy bound to the water molecules 2 is reduced in proportion to the distance from the surface 5. Although attempts are made to keep the float 7 continuously and substantially entirely below the surface of water, in some situations part of the float 7 may be forced to emerge instantaneously above the surface of water.

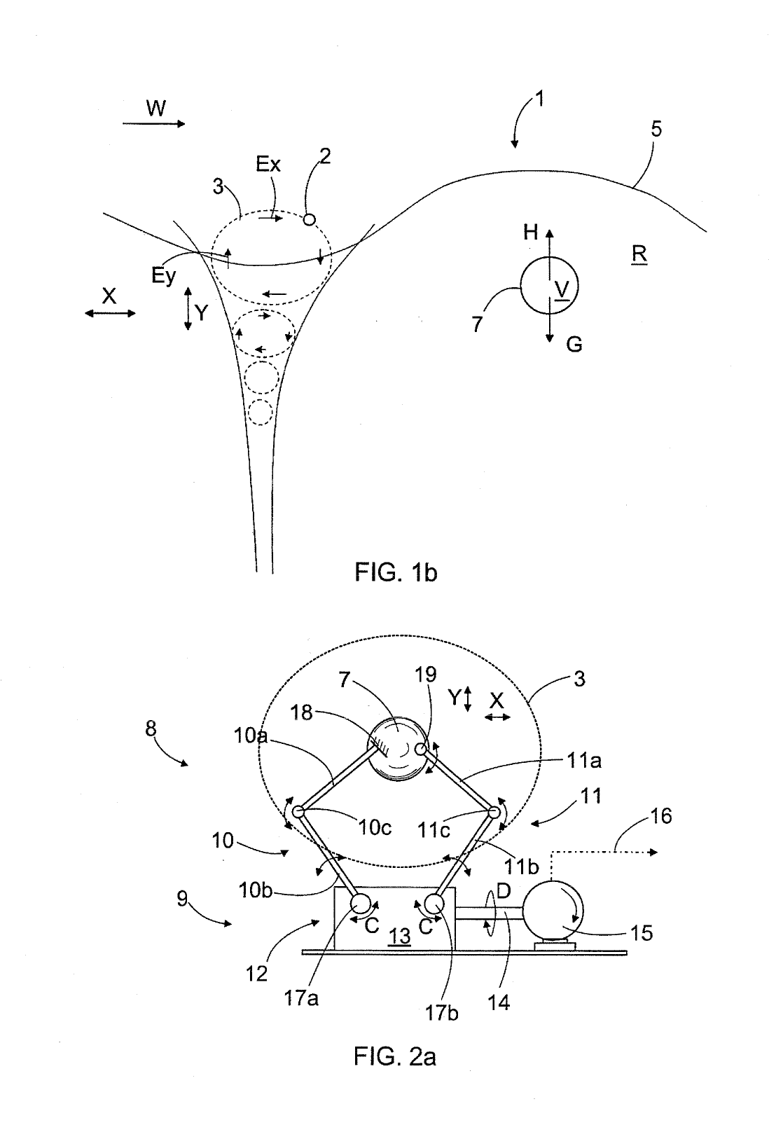

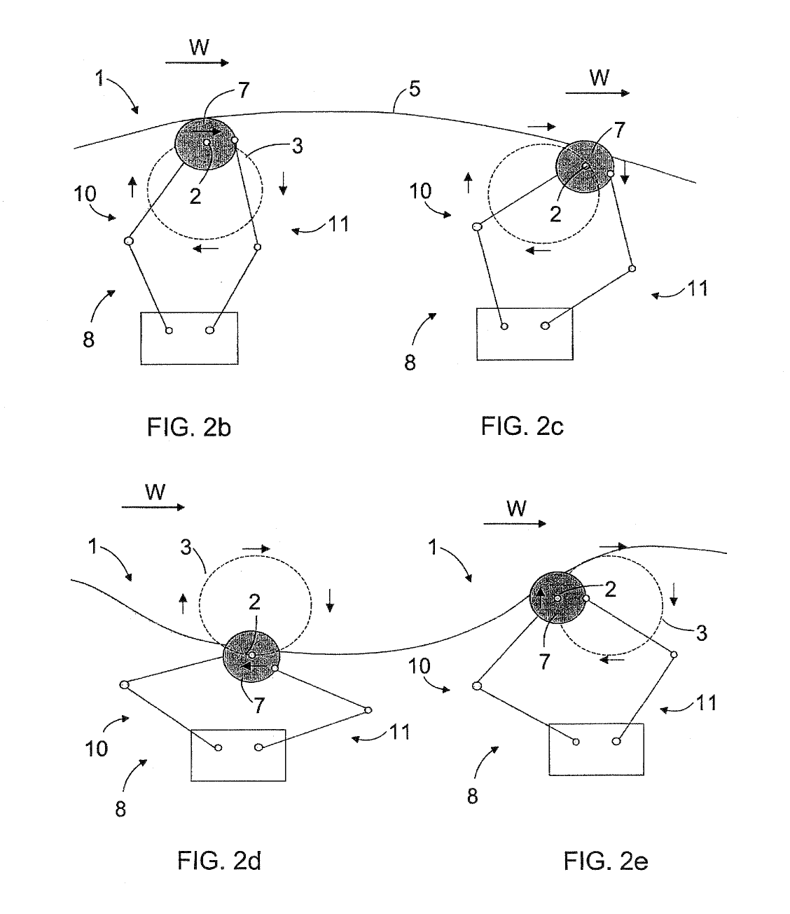

FIG. 2a shows a collecting device 8 that may comprise one or more floats 7, a body 9, and a first support bar 10 and a second support bar 11 for coupling the float 7 to the body 9. The collecting device 8 may further comprise an actuator 12 for receiving the motion of the support bars 10, 11. The actuator 12 may be a motion converter 13 that is able to convert a plurality of reciprocating motions C into a unidirectional rotational motion D. The motion converter 13 may be coupled by means of a power take-off shaft 14 to an energy converter 15, which may be a generator, for example, for converting motion energy into electrical energy. The electricity generated may be conveyed by means of a conductor 16 to an electrical network, for example.

The first support bar 10 may be composed of an upper part 10a and a lower part 10b, which are coupled up by means of an articulation 10c. Accordingly, the support bar or support arm may be a kind of an articulation mechanism. Similarly, the second support bar 11 may comprise parts 11a and 11b, and an articulation 11c. The support bar 10, 11 is an elongated member capable of transferring forces both in its longitudinal direction and its transverse direction. In some cases, the support bar 10, 11 may be a curved piece or otherwise suitably shaped. The motions of the float 7 in different directions can be transferred to the motion converter 13 by means of the support bar 10, 11 or the support arm. The lower end of the support bar 10 is coupled to a feed shaft 17a in the motion converter 13, and, similarly, the lower end of the support bar 11 is coupled to a feed axis 17b. The upper end of the support bar 10 is coupled to the float 7 with a fixed fixation 18 without articulation, whereby the upper part 10a of the support bar 10 is immobile relative to the float 7. However, the movement of the float 7 causes the articulation 10c to move relative to the motion converter 13, whereby the lower part 10b of the support bar 10 turns the feed shaft 17a in direction C. Furthermore, the upper part 11a of the second support bar 11 may be coupled to the float 7 by means of the articulation 18.

The float 7 shown in FIG. 2a may be a substantially spherical piece having a round or oval cross-section. Alternatively, the float 7 may be some other floating container provided with a curved outer surface.

FIGS. 2b to 2e illustrate the action of water 1 on the operation of the collecting device 8. The potential energy and motion energy comprised by a wave 1 make the float 7 move along a circular or elliptical, curved path 3. As the figures show, a bar 10, fastened rigidly to the float 7, keeps the float continuously in a position allowing the float 7 to move along the curved path 3.

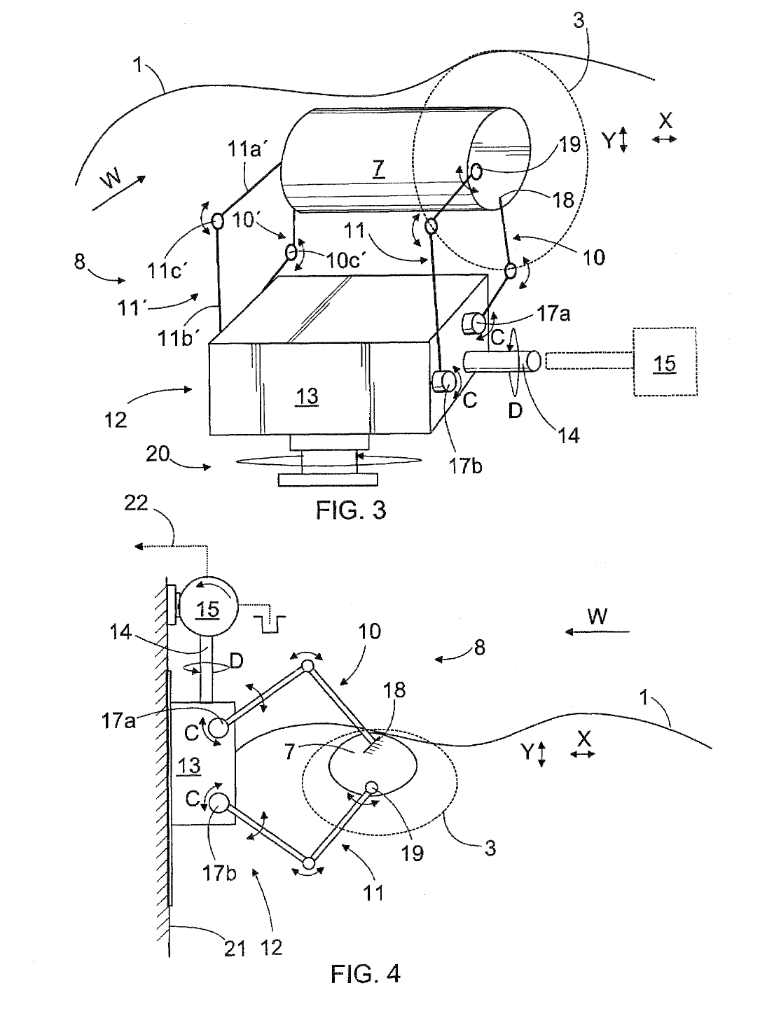

The collecting device 8 shown in FIG. 3 comprises a cylindrical float 7, whose cross-section may be round or oval, or furthermore, the outer surface of the cross-section may be composed of a plurality of curved parts. The float 7, provided with a curved shape, may have a lower friction when moving in liquid than a float provided with an angular shape. Furthermore, the elongated float 7 has a large surface area for receiving wave 1 energy. The collecting device 8 may be arranged in such a manner that its elongated float 7 is transversely relative to the direction of motion of the wave 1 under normal wave conditions. Furthermore, it is possible to provide the collecting device 8 with a turning mechanism 20, which enables the turning of the entire collecting device 8 or only one float 7 according to the direction of motion of the waves 1. Automatic means for identifying the direction of motion of the waves and for adjusting the position of the float 7 accordingly may also be arranged in connection with the collecting device 8. Furthermore, it is possible to immerse the float 7 deeper into the water for instance during storms or when the surface of water is frozen and thus prevent the collecting device 8 from being damaged.

The elongated float 7 may be supported at its first end by means of support bars 10 and 11 and at its second end by means of support bars 10′ and 11′. The support bars 10 and 10′ may be coupled to the same or a different feed shaft 17a, and similarly, the support bars 11 and 11′ may be coupled to the same or a different feed shaft 17b.

In FIG. 4, the collecting device 8 is fastened to a vertical wall surface 21, such as for example the wall of a pier, a support leg of an oil-drilling rig, a breakwater or another suitable location. The collecting device 8 shown in FIG. 4 may be substantially similar to the device shown in FIG. 3. The motion converter 13 may be arranged to operate a pump, which in this case acts as the energy converter 15. The pump may be arranged to pump water, hydraulic medium, such as oil, or it may be arranged to pump some suitable gas, such as air, for example. The pressure medium may be conveyed out from the pump along a conduit 22.

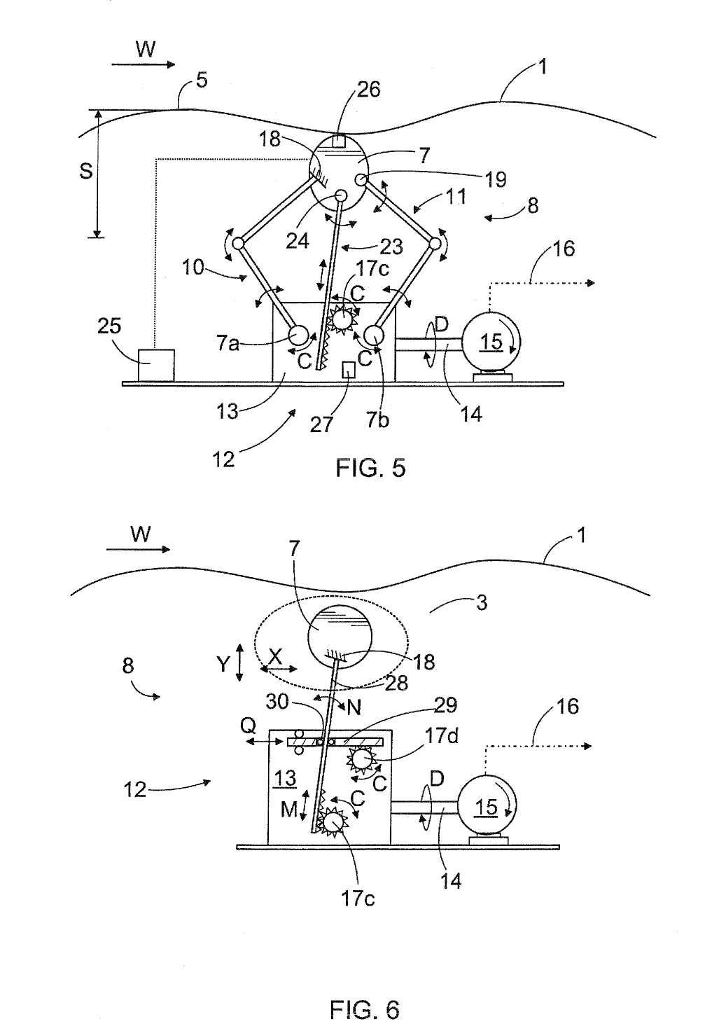

In the collecting device 8 shown in FIG. 5, the cross-section of the float 7 is oval. Furthermore, the float 7 may be supported not only with the support bars 10 and 11, but also with a third support bar 23. Alternatively, the third bar 23 may replace the support bar 11. The upper end of the third support bar 23 may be articulated with an articulation 24 to the float 7 and its lower end may be arranged to operate the feed shaft 17c of the motion converter 13. The lower end of the third support bar 23 may be provided with a toothing and similarly, the feed shaft 17c may comprise a toothed wheel, whereby the longitudinal motion of the third support bar 23 achieves the reciprocating motion of the feed shaft 17c in direction C.

The collecting device 8 shown in FIG. 5 may further comprise an adjusting device 25 for adjusting the mass of the float 7 in such a manner that the float 7 can be placed in a surface depth, at the desired distance S from the surface 5 of water. The adjusting device 25 may be arranged to let water into the float 7 or remove water from it. Other manners of adjusting the mass may naturally be applied. The float 7 may comprise one or more sensors 26, which may identify the position of the float 7 relative to the surface 5 of water. Alternatively, one or more sensors 27 may be arranged in connection with the motion converter 13 for determining the vertical position of the float 7 on the basis of the paths of the feed shafts 17.

FIG. 6 shows a collecting device 8, whose float 7 may be coupled by means of one support bar 28 to an actuator 12. The upper end of the support bar 28 is coupled with a fixed fixation 18 to the float 7, whereby the support bar 28 moves in the longitudinal direction M and turns in direction N. The support bar 28 may comprise means for transferring its motion in the longitudinal direction M to the feed shaft 17c. Furthermore, the support bar 28 may be coupled to a slide 29, by means of which the turning motion N can be converted into a linear motion Q. The slide 29 may be arranged to operate the feed shaft 17d. A coupling may exist between the slide 29 and the support bar 28, which does not receive the longitudinal motion M of the support bar 28, but only transfers transverse motion. The slide 29 may comprise an opening that may be provided with a suitable bearing 39 in such a manner that the support bar 28 is allowed to move freely in its longitudinal direction.

Let it be pointed out that the floats 7 shown in FIGS. 4, 5, and 6 may be elongated cylinders or other kinds of floating containers.

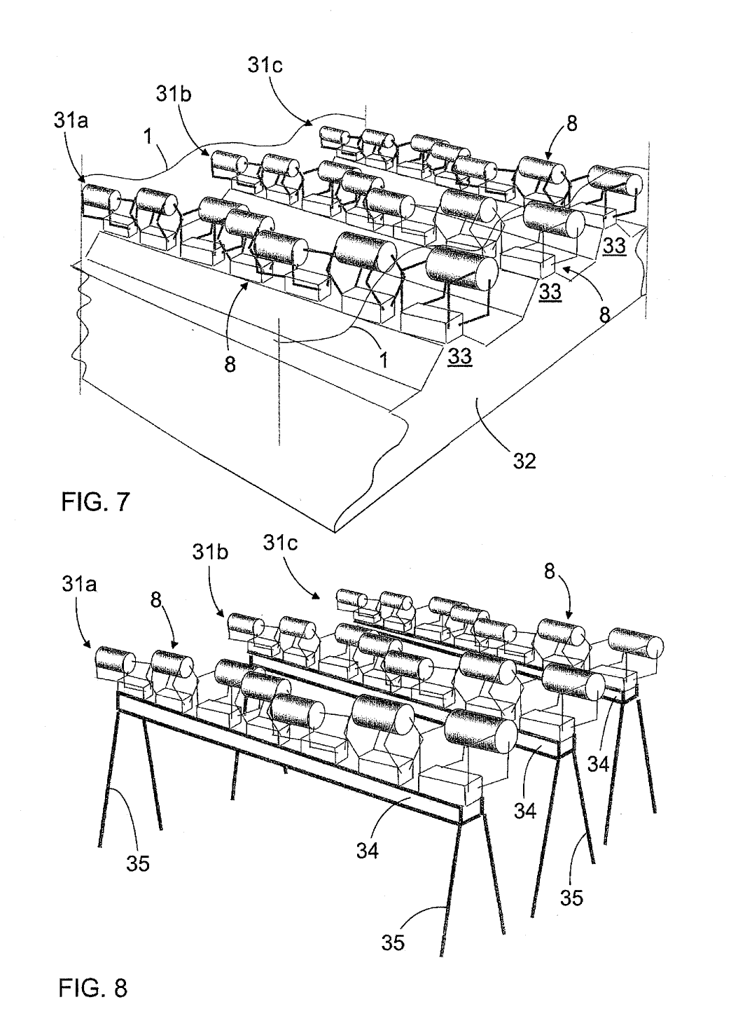

In FIG. 7, a plurality of collecting devices 8 is arranged in such a manner that they form a kind of ‘collecting device park’ having a plurality of rows 31a to 31c. The collecting devices 8 on the first row 31a receive the wave 1 first, whereby they are able to collect a larger amount of energy from the wave than the collecting devices 8 of the following rows 31b and 31c. However, a large amount of energy remains in the wave 1 that has passed the first row 31a, and that energy can be recovered with the collecting devices 8 arranged in the following rows 31b and 31c. The collecting devices 8 are arranged in such a manner that adjacent devices do not interfere with each other.

FIG. 7 further shows that the collecting devices 8 may be supported to the bottom of the water system by means of a support structure 32. The support structure 32 may be a kind of embankment 33, by means of which the collecting devices 8 can be placed at a suitable distance from the surface of water. When need be, the support structure 32 may be constructed on some suitable platform in the water instead of the bottom of the water system. Together, the support structure 32 and the collecting devices 8 may constitute a breakwater.

FIG. 8 shows a second alternative for supporting the collecting devices 8 to the bottom of a deep sea, for example. The support structure 32 may be a grid structure or a suitable console 34, which supports the collecting devices 8, arranged as rows 31a to 31c, by means of support feet 35.

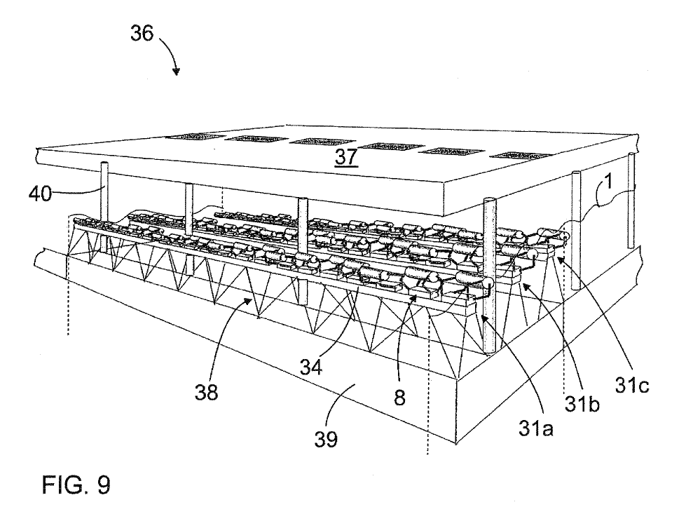

FIG. 9 shows a structure 36 comprising a cover 37 and a plurality of collecting devices 8 arranged below the cover. The collecting devices 8 may be supported by means of consoles 34 and grid structures 38 or in some other suitable manner. Furthermore, the collecting devices 8 may be arranged as rows 31a to 31c in the manner shown in the previous FIGS. 7 and 8. In addition, the structure 36 comprises a bottom piece 39, which may support the cover 37 by means of supports 40. Alternatively, the cover 37 is supported by means of the supports 40 directly to the bottom of the water system. The bottom piece 39 may be a floating piece. The cover 37 may act as an airfield, platform for solar cells or windmills or as a foundation for buildings. Since the waves 1 are able to pass between the cover 37 and the bottom piece 39, the loading caused by the waves 1 to the structure 36 is relatively small. Alternatively, the collecting devices 8 may be supported to the lower surface of the cover 37 directly or by means of some suitable support structure.

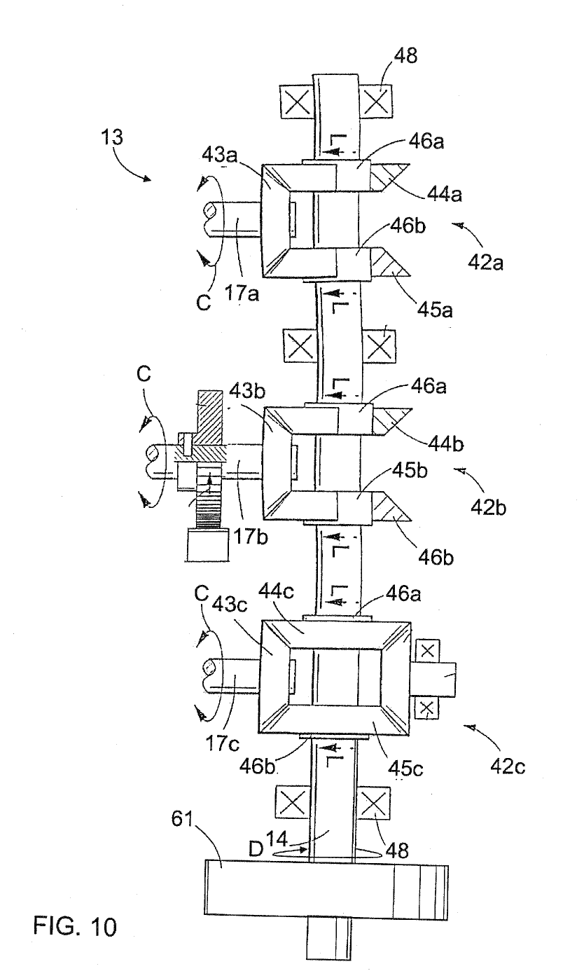

FIG. 10 shows the principle of a motion converter 13. The support bars of the float may be arranged to turn feed shafts 17a to 17c back and forth in direction C. The swinging motion of the feed shafts 17a to 17c is transferred to direction deflection means 42a to 42c, which may comprise first toothed wheels 43a to 43c, second toothed wheels 44a to 44c, and third toothed wheels 45a and 45b. Furthermore, the direction deflection means 42 may comprise dummy couplings 46a and 46b, whose detaining direction is denoted by arrow L in FIG. 10. A power take-off shaft 14 is supported with bearings 48 to the body of the motion converter 13. When the reciprocating motion is brought with each feed shaft 17 to the first toothed wheel 43, the motion is transferred to the second toothed wheel 44 and similarly, to the third toothed wheel 45. The second toothed wheel 44 is able to transfer the motion by means of a dummy coupling 56a in one direction to the power take-off shaft 14, whereby the dummy coupling 56a does not transfer the rotational motion in the opposite direction. Similarly, the third toothed wheel 45 is able to transfer the motion by means of a dummy coupling 56b in one direction to the power take-off shaft 14, whereby the dummy coupling 56b does not transfer the rotational motion in the opposite direction. The detaining directions L of the dummy couplings 56 are selected in such a manner that the power take-off shaft 14 rotates in one direction D. A necessary number of feed shafts 17 may be coupled to the motion converter 13. In the solution according to FIG. 1, the number of feed shafts 17 to be coupled to the motion converter 13 may be two, in the solution of FIG. 3, the number of feed shafts 17 to be coupled may be four, in the solution of FIG. 5, the number of feed shafts 17 to be coupled may be five, and further, in the solution of FIG. 6, the number of feed shafts 17 to be coupled may be one. Furthermore, it is possible to couple the feed shafts 17 of a plurality of collecting devices 8 to the same motion converter 13, whereby the number of feed shafts 17 may be large. In addition, it is possible to couple one or more flywheels 61 to the power take-off shaft 14 or to another suitable location in the motion converter 13, which may even out the rotational motion generated by the motion converter 13.

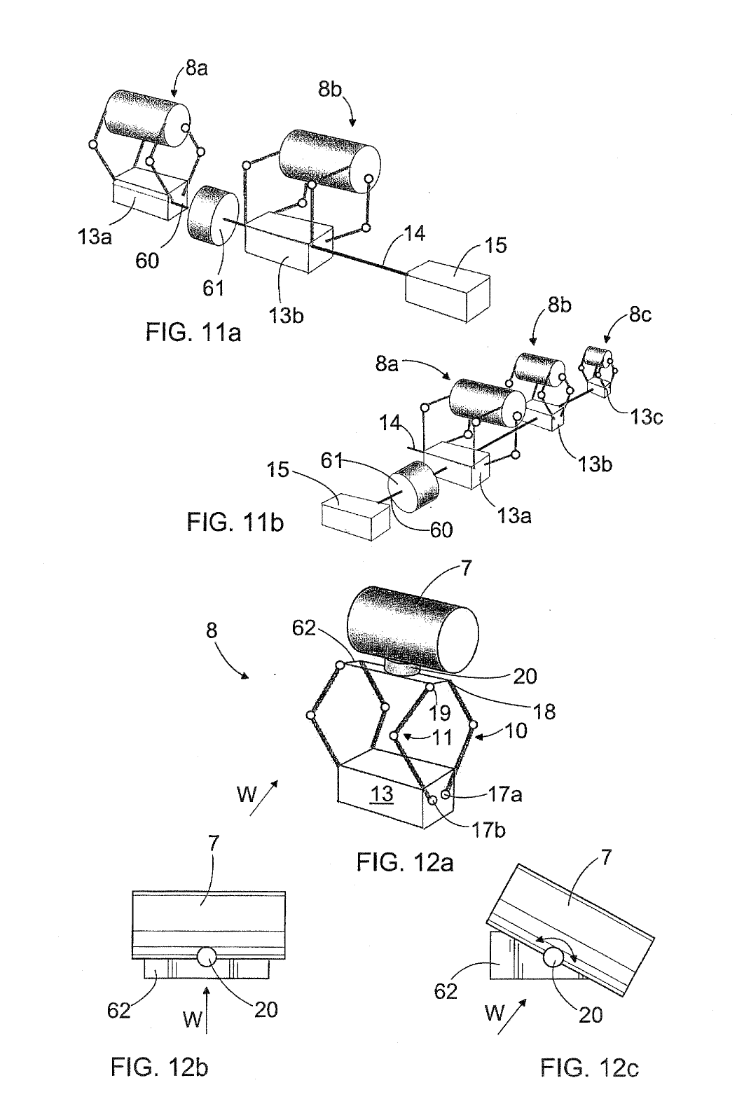

In FIG. 11a, two collecting devices 8a, 8b are coupled up by means of a shaft 60. Furthermore, one or more flywheels 61 may be coupled to the shaft 60 for evening out the rotational motion generated with the motion converters 13a, 13b. The shaft 60 and the flywheel 61 may be arranged between two parallel or two successive collecting devices. In FIG. 11b, three consecutive collecting devices 8a, 8b, 8c are coupled up by means of the shaft 60, and their common power take-off shaft 14 is provided with one or more flywheels 61 for evening out the rotational motion. In the solutions according to FIGS. 11a and 11b, a necessary number of flywheels 61 may be placed in the intermediate shafts 60, the power take-off shaft 14 and the internal structures of the motion converters 13.

FIG. 12a shows a collecting device 8, wherein a float 7 is coupled by means of a turning device 20, a turning support 62 and support bars 10, 11 to a body, the body being the casing or body of an actuator 12 or a motion converter 13. The upper end of the support bar 10 is coupled with a rigid fixation 18 to the turning support 62, and the upper end of the support bar 11 is coupled by means of an articulation 19 to the turning support 62. Although the support bars 10, 11 are coupled to the float 7 through the turning support 62 and the turning device 20, this coupling corresponds functionally to a situation wherein the upper ends of the support bars 10, 11 are fastened directly to the float 7, as was shown in the previous figures. The turning device 20 enables the turning of the float 7 in accordance with the direction W of the waves. As is seen from FIGS. 12b and 12c, the turning device 20 may be arranged eccentrically relative to the mid shaft of the elongated float 7, whereby the float 7 always tends to turn in such a manner that its mid shaft is transverse relative to the direction W of travel of the waves. The turning device 20 enables substantially only a turning around the vertical shaft.

In some cases, the float 7 may be fastened without articulation or turning device to the support member. Such a support member may be for instance a fixed or detachable lug in the float or another projection, to which the upper ends of the support bars may be fastened in such a manner that at least the upper end of one support bar has a rigid fixation to the support member.

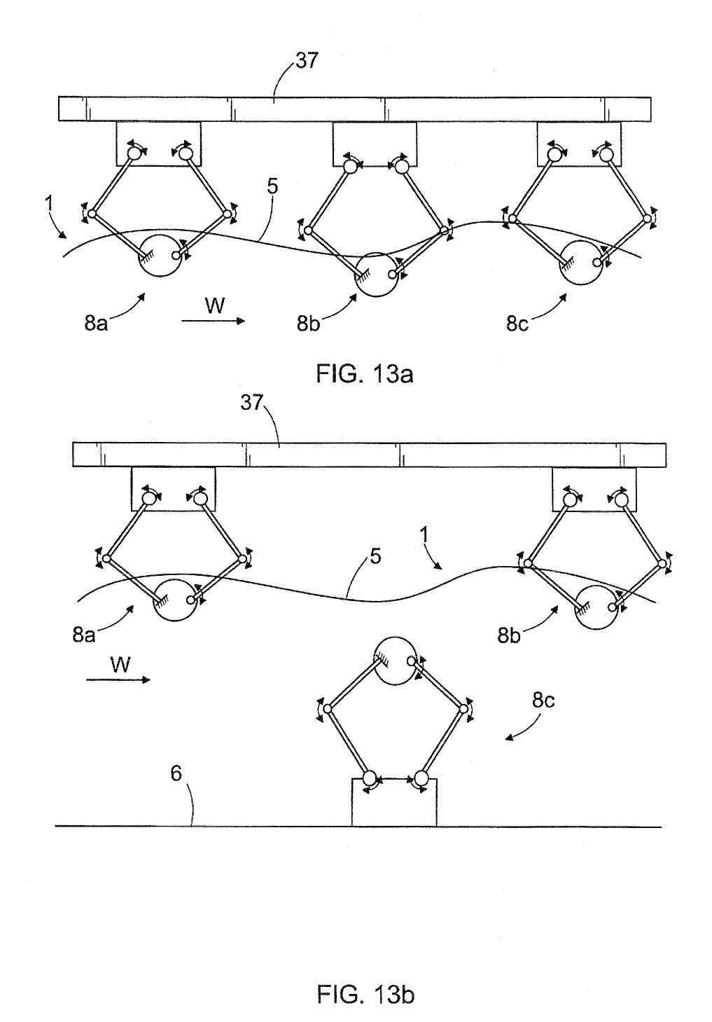

FIG. 13a shows a superstructure 37 to be arranged above the surface 5 of waves 1 and to which one or more collecting devices 8a to 8c may be fastened. The superstructure 37 may be a bridge or a pier, for example, under which the collecting devices 8a to 8c may be arranged.

In FIG. 13b, collecting devices 8a, 8b are arranged between a superstructure 37 and the upper surface 5 of water, and at the bottom 6 of a water system. Such an arrangement may be applied to rivers and other streaming water systems, for example. The collecting devices 8a, 8b coupled to the superstructure 37 and the collecting devices 8c arranged at the bottom 6 may be arranged alternately in the longitudinal direction and the lateral direction of the water system, whereby the collecting devices 8a to 8c may overlap, which is advantageous as regards the use of space.

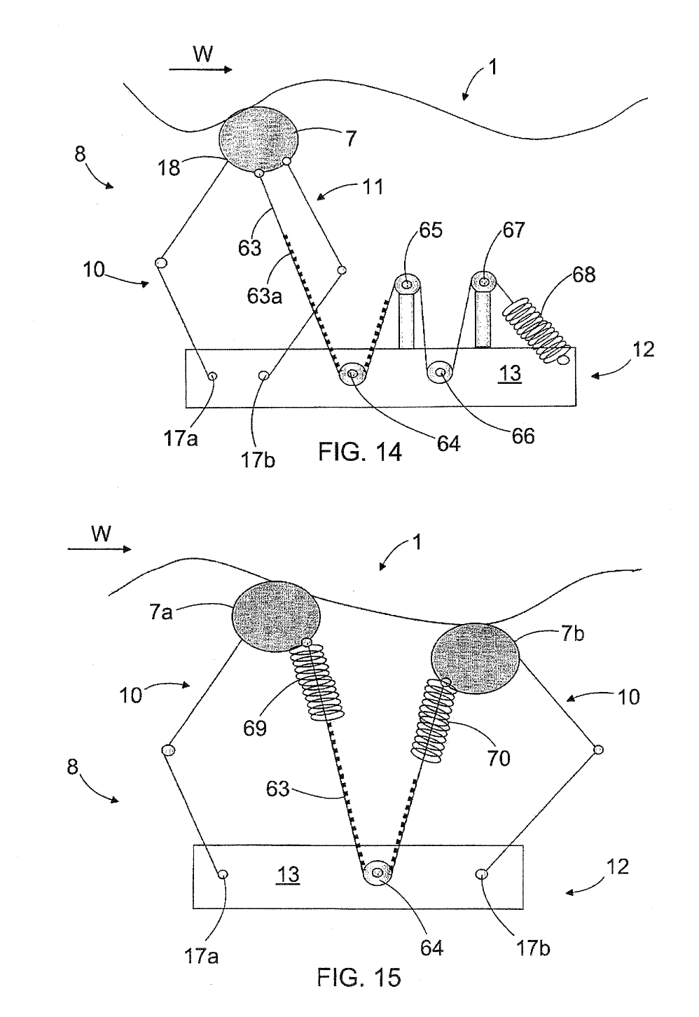

In FIG. 14, a flexible power transmission member 63, such as a transmission belt, chain, wire rope, rope or the like, is coupled to the float 7. The flexible power transmission member 63 is preferably a toothed belt provided with teeth 63a. The flexible power transmission member 63 is used to transfer the movement of the float 7 to an actuator 12, which may be a motion converter 13. The flexible power transmission member 63 may be arranged to pass via one or more pulley wheels 64 to 67. Furthermore, the flexible power transmission member 63 may be fastened by means of one or more spring members 68 to the actuator 12. The movement of the float 7 by the action of the waves 1 causes a longitudinal motion in the flexible power transmission member 63, and by the action of this motion the pulley wheels 64 to 67 rotate, and the spring member 68 generates an opposing force to this longitudinal motion. One or more pulley wheels 64 to 67 may be coupled to the feed shaft of the motion converter 13 in such a manner that the reciprocating motion of the power transmission member 63 can be recovered. In addition, the bars 10, 11 may be coupled at their lower ends to feed shafts 17a, 17b.

The collecting device 8 shown in FIG. 15 comprises two floats 7a, 7b, coupled up by means of a flexible power transmission member 63. Furthermore, the flexible power transmission member 63 is arranged to pass via a pulley wheel 64, which, in turn, is coupled to the feed shaft of a motion converter 13. The flexible power transmission member 63 may be coupled by means of a first spring member 69 to the first float 7a and by means of a second spring member 70 to the second float 7b. The spring members 69, 70 can be used to affect the paths of the floats 7a, 7b and to attenuate the motions.

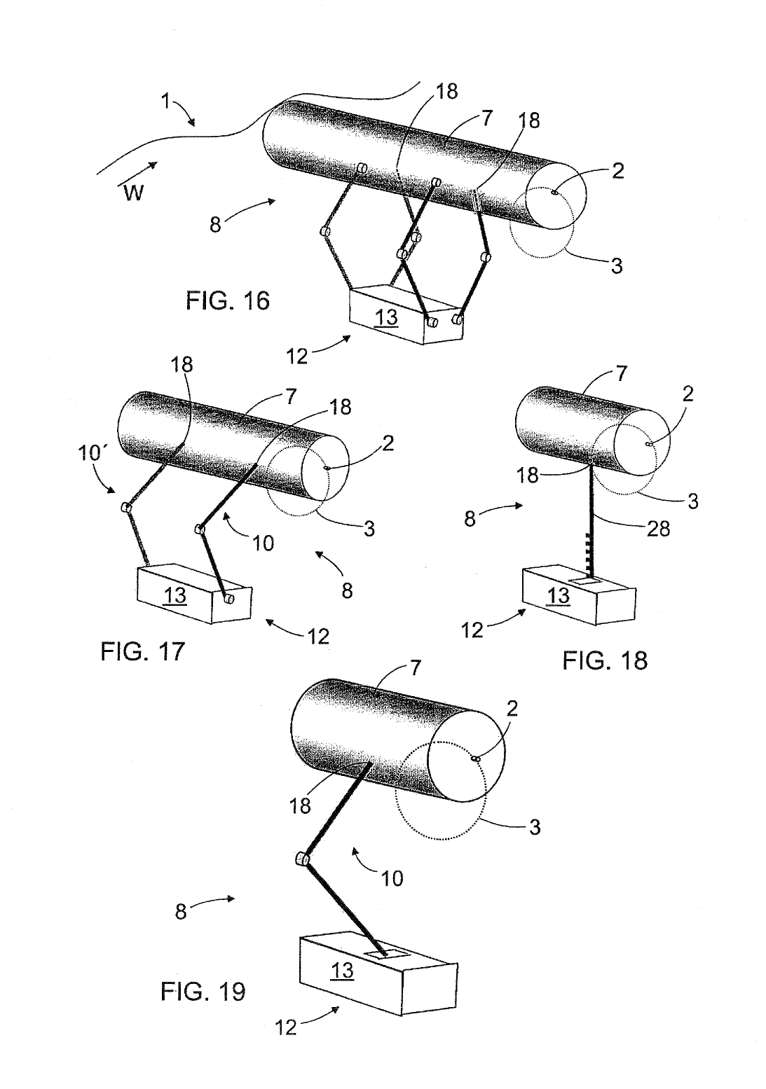

FIGS. 16 and 17 show collecting devices 8 comprising an elongated float 7 supported by means of support bars 10, 11 at the middle portion of a float 7. In this case, the float 7 may be relatively long without the body of the collecting device and support structure having to be long. In FIG. 16, the support bars 10, 11 are arranged on both sides of the float, whereas in FIG. 17, the support bars are arranged only on one side of the float 7.

In FIG. 18, one toothed bar 28 is arranged at the middle portion of a float 7, i.e. at a distance from the end surfaces of the float, the toothed bar being used to support the float to the body of the collecting device 8 and to transfer the movements of the float to an actuator 12. In the solution shown in FIG. 19, in contrast, the float 7 is supported by means of one support bar 10 at the middle portion of the float 7.

Let it be mentioned further that in some cases support bars are not used, or at least not all support bars are used, to transfer the movement of the float to the feed shaft of the motion converter; instead, a flexible band or the like, for example, may act as the power transmission member. In this case, the support bars may be articulated at their lower ends by means of a suitable articulation to the body of the collecting device, whereby they support the float, but do not transfer the motion to the motion converter.

In some cases, the features presented in the present application can be employed as such, irrespective of other features. On the other hand, the features presented in the present application can be combined for generating various combinations, when need be.

The drawings and the related description are only intended to illustrate the idea of the invention. The details of the invention may vary within the scope of the claims.

1-12. (canceled)

13. A method of recovering energy contained by waves, the method comprising the steps of:
placing a float in water, where the waves are able to move the float;
arranging the float substantially entirely below water-level;
coupling the float by means of at least one support bar to a body;
transferring a movement of the float by means of at least one power transfer member to at least one actuator; and
receiving a reciprocating motion generated by the float with the actuator,
coupling at least one support bar rigidly to the float; and
transferring a horizontal and vertical movement of the float with at least one support bar rigidly fastened to the float.

14. A method as claimed in claim 13, comprising:
transferring a movement of the float by means of at least one support bar mechanically to the actuator located in the area of an opposite end of the support bar.

15. A collection device for recovering energy contained by waves, the device comprising:
at least one float positioned to float in water and move in accordance with the waves in a vertical direction and in a horizontal direction;
a body;
at least one support bar comprising a first end and a second end and fastened at its first end to the float and at its second end to the body;
at least one means for articulating the second end of the support bar and the body rotationally to each other; and
at least one actuator arranged to receive a movement of the float via at least one power transmission member,
said at least one support bar being fastened rigidly to the float without articulation between the float and said support bar, and
at least one support bar being fastened rigidly to the float is arranged to transfer horizontal and vertical movements of the float.

16. A collecting device as claimed in claim 15, wherein a lifting force of the float is dimensioned in such a manner that the mutual relationship between gravitation and the lifting force that the float is subjected to positions the float substantially entirely below water-level.

17. A collecting device as claimed in claim 15, wherein the collecting device comprises means for adjusting the mass of the float, whereby the mutual relationship between gravitation and the lifting force that the float is subjected to is adjustable in such a manner that the float is located a predetermined distance from the water-level.

18. A device as claimed in claim 15, wherein the cross-section of the float is substantially round.

19. A collecting device as claimed in claim 15, wherein the float is an elongated, substantially cylindrical piece.

20. A collecting device as claimed in claim 15, wherein the actuator is a motion converter arranged to convert a reciprocating motion of the support bar into a unidirectional rotational motion; and
the motion converter is coupled to transfer the rotational motion to at least one energy converter for converting motion energy into electrical energy or pressure energy.

21. A collecting device as claimed in claim 15, wherein at least one support bar comprises at least two bar parts coupled up by means of at least one articulation, thus constituting an articulated structure.

21. A collecting device as claimed in claim 15, wherein a horizontal movement of the float is restricted in a direction transverse relative to a travel direction of the wave.

22. A collection device for recovering energy contained by waves, the device comprising:
at least one float arranged to float in water and move in accordance with the waves in a vertical direction and in a horizontal direction; a body;
at least one support bar for coupling the float to the body, the support bar comprising a first end and a second end;
at least one means for articulating the second end of the support bar and the body rotationally to each other; and
at least one actuator arranged to receive a movement of the float via at least one power transmission member,
the float being coupled to at least one support member;
the support bars being coupled at their first ends to the support member; and
at least one support bar being fastened to the support member rigidly without articulation between the support member and said support bar, and
at least one support bar being fastened rigidly to the support member is arranged to transfer horizontal and vertical movements of the float.

23. A collecting device as claimed in claim 22, wherein the float is coupled to the support member by means of a turning member, the float being arranged around a vertical shaft rotationally relative to the support member.
